(19) United States
(12) Patent Application Publication
(10) Pub. No.: US 2023/0360495 A1
(43) Pub. Date: Nov. 9, 2023

(54) DAGGER SPORTS BETTING SYSTEM AND METHOD

(71) Applicant: Jeffery Lipp, Plantation, FL (US)

(72) Inventor: Jeffery Lipp, Plantation, FL (US)

(21) Appl. No.: 18/312,581

(22) Filed: May 4, 2023

Related U.S. Application Data
(60) Provisional application No. 63/339,956, filed on May 9, 2022.

(51) Int. Cl. G07F 17/32; G06Q 50/34

(52) U.S. Cl. CPC G07F 17/3288; G07F 17/323; G07F 17/3239; G07F 17/3255; G07F 17/3241; G06Q 50/34

(57) ABSTRACT

A dagger sports betting system and method capable of handling volume and variety of dagger bets placed by a plurality of users available across the sports betting system with fixed odds betting, where bets are typically set by electronic algorithms designed to account for a large number of variables and events as they occur, in real-time.

### CROSS-REFERENCE TO RELATED APPLICATION

This application is related to and claims benefit to U.S. Provisional Patent Application Ser. No. 63/339,956, filed May 9, 2022, entitled DAGGER BETTING SYSTEM AND METHOD, the entirety of which is incorporated herein by reference.

### FIELD OF THE INVENTION

The present invention relates to sports betting system and method, and more particularly to a dagger sports betting system and method that provides users with the ability to place one or more digital dagger sports bets on one or more of games, matches, competitions, or events.

### BACKGROUND OF THE INVENTION

Sports betting is a type of game and/or gambling for predicting the outcome of sports, games, matches, competitions or other events for financial gain. Some of the major sports for sports betting includes football, soccer, and basketball. With the advent of computers and internet, online sports betting has proliferated over computers and mobile based apps. Online sports betting has become more and more interactive to allow for more customized sports betting.

While the online sports betting model has become more popular and allowed for more customized sports betting over the internet, the types of bets that can be placed on the outcome of sporting events have remained relatively the same.

There is a need in the art for a system and method that facilitates the sports betting process to introduce a new betting system and method that creates interest and excitement at various points of the sporting event. Further, there is a need for a real-time betting platform that adjusts various odds in real-time to facilitate a new betting game. Such a needed method would attract increased interest of spectators as they can place wagers on unique aspects during games, including games that may already have wide-ranging point spreads.

### SUMMARY OF THE INVENTION

The present invention advantageously provides a dagger sports betting system and method that provides users with the ability to place one or more digital dagger sports bets on one or more of games, matches, competitions, or events.

The term “dagger”, “dagger shot,” and/or “dagger point” refers to the last scored, or otherwise awarded, or otherwise received, goal, shot, and/or point that puts the winning person and/or team permanently ahead prior to and until the conclusion of a game, match, tournament, or event when a winner of the game, match, tournament, or event results. The dagger point may reference a specific person or specific team to make a shot, goal, or point, including without limitation in basketball, soccer, tennis, baseball, volleyball, badminton, football, wrestling, hockey, and gymnastics.

The term “dagger bet” refers a sports bet made as a dagger wager predicting at least one of the team and/or person that scores or otherwise earns the dagger point. The dagger bet may also or alternatively be made in reference to the timing of the dagger point. It is within the scope and spirit of the instant embodiment that any conceivable time or timing during the sporting event may qualify for a dagger bet. For example, a user may wager on one or both of the particular player and the timing of the dagger point. In yet another example, a user may wager the combination of the team and the timing of the dagger point.

According to an embodiment of the present invention, a principal object is to provide a dagger sports betting system and method capable of handling volume and variety of dagger bets placed by a plurality of users available across the sports betting system with fixed odds betting, bets are typically set by electronic algorithms designed to account for a large number of variables and events as they occur, in real-time, which would not otherwise be feasible to be done without the use of a computer.

In one non-limiting embodiment, a user may place a dagger bet that a particular player will score the dagger, regardless of the timing.

In one non-limiting embodiment, a user may place a dagger bet that the dagger will occur at a particular time, regardless of the particular player or team that scores or otherwise earns the dagger.

In one non-limiting embodiment, a user may place a dagger bet that the dagger will occur at a particular time and/or time range relating to a particular person and/or team.

In one non-limiting embodiment, a user may place a dagger bet that the dagger will occur during a group of times and/or a group of time ranges. For example, the dagger bet may be a wager that the dagger will occur in the first five minutes of any quarter, period, or other identified of time frame(s). The group of times may be non-standard, such as for exemplary purposes the group of times including first five minutes of first quarter, last minute of the first quarter, and minutes 7-9 in the third quarter.

In one non-limiting embodiment, the sports betting system may accept dagger bets for any player or any team, or the dagger bet may be limited for the group of times and/or group of time ranges to particular players and/or teams.

In one non-limiting example, a user may place a dagger bet that a particular player, such as a basketball player, will score a dagger shot during a particular timeframe, such as in the third quarter.

In another non-limiting embodiment, a user may place a dagger bet that the dagger point will occur within a specified time range. For example, the user may place a dagger bet that the dagger point will occur between the first and third minute of the fourth quarter. For another example, the user may place a dagger bet that the dagger point will occur between the last five minutes of the third quarter and the first ten minutes of the fourth quarter.

The dagger bet may be offered in various formats, such as a bet on the particular person to score the dagger point and/or a particular team to score the dagger point.

The dagger bet may also be offered as a sports wager based on the timing of the wager. For example, the system and method may allow a user to place a dagger bet over the sports betting platform that a particular person and/or team will score the dagger point at a particular time, such as in the third quarter.

The dagger bet offered and/or provided to users over the sports betting platform may be combined with unique specifics of the bet. For example, in baseball, a user may place a dagger bet on the sports betting platform for a unique combination, such as the particular person hitting and/or scoring the dagger point. The user could further or alternatively place a dagger bet on the inning when the dagger point will be scored. Yet further, the user could further or alternatively place the dagger bet on the type of point scored, such as a single, double, triple, RBI, homerun, or grand slam. In yet another example, in basketball, a user may place a dagger bet on the sports betting platform for the player that scores the dagger shot and the type of dagger shot, such as three point shot, field goal, dunk, or free throw point.

In yet another embodiment, the sports betting platform may accept bets on the player that assists with scoring the dagger. For example, in hockey, the sports betting platform may allow or provide for a dagger assist bet on the player that assists in scoring the dagger point. Yet further, the sports betting platform may allow users to place wagers on whether the dagger point will occur from an assist of another player or not and/or the specific player to assist with the dagger.

In one non-limited embodiment, the sports betting platform offer users across the sports betting platform via user device one or more dagger bets for any unlimited number of combinations of dagger bets and/or dagger assist bets combined with other dagger bets in the same sport and/or or different sports and/or other traditional and known bets.

In one non-limiting embodiment, the sports betting platform offer users dagger bets with odds that are adjusted in real-time or semi-real time across the platform using a variety of statistics of live game events and/or statistics. In this embodiment, the sports betting server adjusts the odds based on the available statistics and/or past results of players and teams.

In one non-limiting embodiment the dagger bet odds will adjust during the sports competition in real-time to account for the changes to live game statistics. In one non-limiting embodiment, the dagger bet odds may be adjusted during game play to allow for continued dagger bets during live competition.

In one non-limiting embodiment, new dagger bets may be offered in real-time via the sports betting server automatically based on real-time statistics of live sporting events. For example, during sporting events where one team is ahead, a new dagger bet may be offered such that the user can bet that a new team or player earn the dagger.

In one non-limiting embodiment, a dagger sports betting system and method is provided for handling a time-period based dagger bet on the outcome of two or more events involving at least two dagger points. For example, a time-period based dagger bet may be placed such that a particular player will score a set number, such as ten or more, dagger points in a season or other selected time-period. For another non-limiting example, a time-period based dagger bet may be placed such that a particular group of players will score a set number, such as ten or more, dagger points in a selected frame of time, such as a season, half-season, or even a particular day(s), week(s), or month(s).

In one exemplary non-limiting embodiment, time-period based dagger bet may be selected by the user over the sports betting platform from a combination of players from same sport and/or different sports based on an over/under style bet relating to the happening of a set number of dagger points associated with a chosen and/or selected participants in a season and/or a time period.

In yet another exemplary non-limiting embodiment, time-period based dagger bets can be placed based on a combination of chosen and/or selected participants, including from participants that may be on the same and/or different teams, and/or the same or different sports. For example, time-period based dagger bets may be available for selecting a particular basketball player and baseball player to achieve a certain number of total dagger bets in combination within a selected time period.

In yet another exemplary non-limiting embodiment, time-period dagger bets can be placed based on a combination of chosen and/or selected participants, including from participants that may be on the same and/or different teams, and/or the same or different sports to each achieve or not achieve a certain number of individual dagger points. For example, a time-period based dagger bet may be available for selecting a particular basketball player to achieve a selected number of dagger points and baseball player to not achieve a particular number of total dagger bets within a selected time period.

In yet another exemplary non-limiting embodiment, time-period dagger bets can be offered to users for season totals of player(s) and/or other participant(s) of the event(s) over a time-period such as a season, half-season, day(s), week(s), or month(s).

In yet another non-limiting embodiment, time-period based dagger bets may be selected based on real-time odds provided to the user over the sports betting platform over one or more mobile device.

In one non-limiting embodiment, the odds related to available dagger bets may be adjusted in real-time to account for automatic computer calculated and/or generated predictions of the outcome for live ongoing sporting events. The real-time computer betting system performed by a computer may take into account when a star player is hurt during a game, series, season, or other criteria.

In one non-limiting embodiment, any of the features discussed herein can only be completed by a computer due to the volume and/or complexity of the dagger bets being processed by the system.

In one non-limiting embodiment, the sports betting platform provides users with tools and resources to assist in making informed decisions when placing dagger sports bets, including expert predictions, analysis, and breakdowns of upcoming dagger sports betting options.

In one non-limiting embodiment, the sports betting system provides users with at least one of tools and resources to assist in making informed decisions when placing dagger sports bets, including at least one of expert predictions, analysis, and breakdowns of upcoming dagger sports betting options.

In one non-limiting embodiment, the sports betting system provides users the option to cash out their dagger sports bets before the conclusion of the game or event, based on real-time odds and the current status of their bets.

In one non-limiting embodiment, a user rewards system, wherein users are awarded points, bonuses, or other incentives based on their dagger sports betting activity and performance.

In one non-limiting embodiment, the sports betting system implements security measures to protect user information, account details, and financial transactions related to dagger sports betting.

In one non-limiting embodiment, the dagger sports betting system includes a recommendation engine that suggests dagger sports bets to the user based on a user's betting history, preferences, performance, and other data and/or statistics.

In one non-limiting embodiment, the dagger sports betting system may further include a social networking feature that allows users to connect with other users, share their dagger sports bets, and discuss game and event outcomes, strategies, and analysis.

In one non-limiting embodiment, a dagger sports betting method is provided, the method being performed by one or more processors, including providing a sports betting platform accessible by a plurality of user devices, facilitating communication between said sports betting platform and said user devices over a network, receiving and managing dagger sports bets on said sports betting platform, offering real-time odds and allowing in-game wagering for said dagger sports bets based on data from a real-time event data, updating user account bankrolls based on the outcomes of said dagger sports bets, and enabling users to track statistical data and monitor the progress of their dagger sports bets on said sports betting platform.

In one non-limiting embodiment, a dagger sports betting method is provided, the method being only practically performed by one or more computer processors, including providing a sports betting platform accessible by a plurality of user devices, facilitating communication between said sports betting platform and said user devices over a network, receiving and managing dagger sports bets on said sports betting platform, offering real-time odds and allowing in-game wagering for said dagger sports bets based on data from a real-time event data, updating user account bankrolls based on the outcomes of said dagger sports bets, and enabling users to track statistical data and monitor the progress of their dagger sports bets on said sports betting platform.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a block diagram of an exemplary dagger sports betting system according to an embodiment of the present invention;

FIG. 2 is a block diagram of an exemplary memory to facilitate execution of computer instructions for dagger sports betting system in accordance with the principles of the present embodiment;

FIG. 3 illustrates a flow diagram of dagger bet in accordance with the principles of the present embodiment; and

FIG. 4 illustrates a flow diagram of adjusting a bankroll associated with a user account for a dagger bet win in accordance with the principles of the present embodiment.

### DETAILED DESCRIPTION OF THE INVENTION

The present invention advantageously provides a dagger sports betting system and method for receiving and managing dagger sports bets. The present invention contemplates various types of dagger sports bets and methods of implementation.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

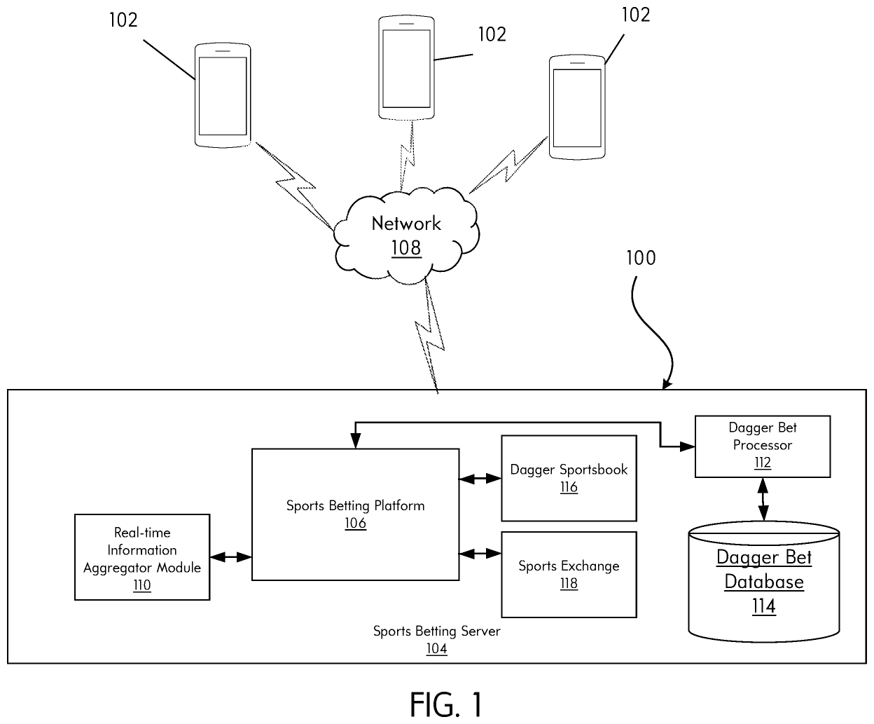

Referring now to the drawings figures in which like reference designators refer to like elements. FIG. 1 shows an exemplary dagger sports betting system constructed in accordance with the principles of the present invention and designated generally as sports dagger betting system “100.” In particular, dagger sports betting system 100 includes plurality of user device 102 in communication with a sports betting server 104 with a sports betting platform 106 over a network 108.

The dagger sports betting system 100 includes a plurality of users accessing the sports betting platform 106 via the plurality of user device 102. The users may include subscribed members to the sports betting platform 106 to track statistical data and bankrolls of each particular subscribed member.

User device 102 may be any computing device (including without limitation smart phones(e.g., a smart phone, including without limitation iPhones and Android phones), desktop computer, laptop, smart device, tablets) with which a user (e.g., sports better) may have user interaction. User device 102 may send and/or receive data to and/or from other devices and systems in FIG. 1, including through network 108. While three mobile device 102 are depicted in FIG. 1, the dagger sports betting system 100 may include a large number of user device 102 for large scale sports betting that would not otherwise be reasonably capable of handling the real-time sports betting completely over the sports betting platform 106.

Network 108 may be any suitable type of network allowing transport of data communications across thereof, and may include, without limitation and for exemplary purposes, the Internet, an intranet, a cellular carrier network, a landline telephone network, a local area network (LAN), a wireless local area network (WLAN), wire-line type connection, and/or a dedicated connection. The plurality of user device 102 may communicate directly or indirectly over the network 108 with the sports betting server and/or other user device 102.

A user may access the sports betting platform 106 via a one of the user device 102. According to a non-limiting embodiment, the sports betting platform 106 offers at least one or both of a sportsbook capable of placing and/or receiving dagger bets against the bookmaker and a betting exchange for betting against other users on one or more other user device 102.

The dagger bet processor 112 may be any suitable processor capable of executing dagger bet software application or other computer instructions, such as a CPU or other microprocessor, and may work remotely or locally, or together with any number of processors working together to run the sports betting platform 106 for receiving the dagger bets for one or both of the dagger sportsbook 116 and the sports exchange 118.

The dagger bet database 114 may include one or more non-transitory tangible computer-readable media storage, such as one or more solid state drives, optical drives, magnetic drives, tape drives, and/or other types of hard drives and/or memory capable of storing data, such memory to store various computer information that may be used by a processor.

The sports betting server 104 further includes a real-time information aggregator module 110 that may retrieve real-time information associated with dagger bets via the dagger bet processor 112, such as real-time scores, statistics, winners/losers, daggers including dagger shots and dagger points. The real-time information aggregator module 110 may be utilized to aggregate scores, daggers, and statistics to determine in real-time dagger bets and dagger wagers to offer over the sports betting platform.

The real-time information aggregator module 110 allows the sports betting platform 106 to offer over the network 108 via one or more non-transitory tangible computer-readable medium real-time in-game dagger bet wagering for real-time bets as the game or sporting event is occurring. For example, the sports betting platform 106 may be able to receive dagger bets for games that have already commenced. The dagger bet processor 112 may adjust the odds of the available dagger bets based on the data from the real-time information aggregator module 110 and/or data in the dagger bet database 114 or from some other database.

The dagger sportsbook 116 allows a user to place a dagger bet against the house.

The betting exchange 118 allows users to bet against other users.

The sports betting platform 106 operates to allow a plurality of users to place bets at least on dagger bets.

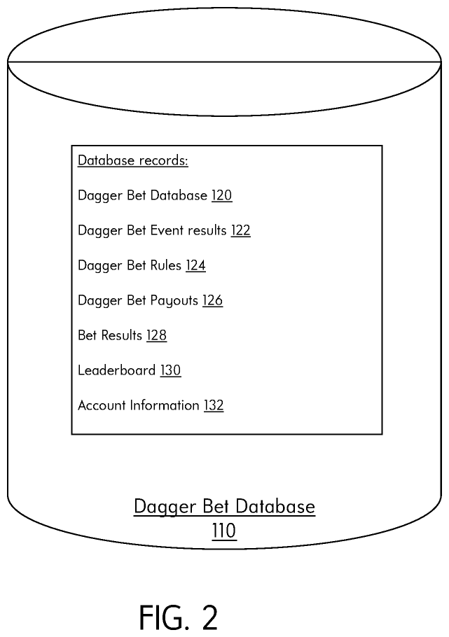

Referring now to FIG. 2, the sports betting server 104 from FIG. 1 includes a dagger bet processor 112 in communication with a database 114 shown in more detail in FIG. 2 and operates to manage bets received from user device 102. The dagger bet processor 112 operates to execute various algorithms and/or calculations to determine various data including dagger bet data 120, dagger bet event results 122, dagger bet rules 124, dagger bet payouts 126, dagger bet results 128, dagger bet leaderboards 130, and account information 132 for users across various user device 102.

The dagger bet processor 112 further causes the display of dagger bet rules 124, dagger bet payouts 126 resulting from winning dagger wagers, dagger bet results 128 including wins and losses, on user device before and/or after the placing of dagger wagers.

In one non-limiting embodiment, the sports betting platform 106 includes a leaderboard where sports betters can compete or otherwise view other users that score points or are otherwise ranked according to the results of the dagger bets alone or in combination with other traditional wagers.

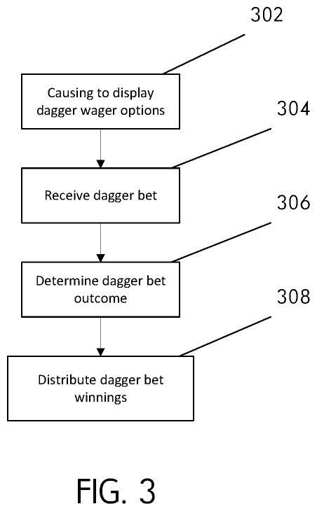

Referring now to FIG. 3, a block diagram is provided of an exemplary process for receiving and paying dagger bets, according to one inventive aspect of the present embodiment. At block 302, the sports betting platform 106 causes to display on one or more user device 102 dagger wager options for a user to select.

In one non-limiting embodiment, when a user selects a particular dagger sports bet, the sports betting platform 106 will provide odds in real-time for a wager to be placed, optionally within a particular time.

At block 304, the sports betting platform 106 receives a dagger bet selected by a user on one or more user device 102. The dagger bet selected by the user stored in the dagger bet database 120 for maintaining dagger bets placed by users. At block 306, the dagger bet processor 112 determines the dagger bet winners and losers following the conclusion of the game or the happening of an event that determines the dagger bet to be unsuccessful. Dagger bet winners and losers may be notified via the sports betting platform 106 of the results of the dagger bet and caused to display on the user device 102. The dagger bet database 114 stores dagger bet results 122 to the storage for retaining wager results. At block 308, the dagger bet processor 112 automatically causes dagger bet payouts 126 to be paid to users across the user device 102. Users may store payout information to the account information 132 of the dagger bet database 110 for facilitating instructions of were to send payouts relating to dagger bets.

Dagger bet payouts 126 may be stored in the dagger bet database as credits to users for making new dagger bets or may be paid out to an account specified by the user associated with banking information stored in the user account information 132.

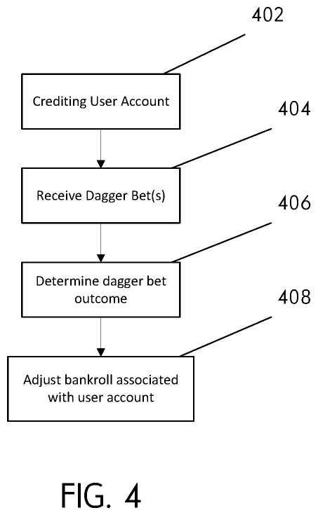

Referring now to FIG. 4, a block diagram is provided of an exemplary process for bankrolling dagger bets, according to one inventive aspect of the present embodiment. At block 402, a user account information 132 is updated to reflect credit associated with a user that provides funds to make dagger wagers. At block 404, one or more users place one or more dagger bets. The sports betting platform 106 may offer various combinations of dagger bets.

In one non-limiting embodiment, the sports betting platform 106 may offer parlay bets of two or more dagger bets.

In one non-limiting embodiment, the sports betting platform 106 may offer a parlay bet that combines one or more dagger bet with one or more traditional and/or previously known wagering.

At block 406, the outcome of the one or more dagger bet is determined. At block 408, a user's account and/or bankroll is adjusted to reflect the outcome of one or more dagger bets.

Any mobile device that has access to network 108 may be able to communicate with the sports betting server 104.

The sports betting server 104 will provide different odds based on the various calculations from the dagger bet processor 112. In one non-limiting embodiment, the sports betting server 104 will utilize real-time data in calculating betting odds for available dagger bets. In one non-limiting embodiment, the sports betting server 104 will determine betting odds to offer for available dagger bets from past results and/or statistics from prior players and/or games. In one non-limiting embodiment, the sports betting server 104 will determine in real-time the odds based on a combination of past statistics of dagger points of dagger wagering to offer to users across the sports betting platform 106 to selected across a plurality of user device 102.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure.

What is claimed is:

1. A method for managing dagger sports bets in a sports betting system, the method comprising:
receiving user input for placing a dagger sports bet through one or more user devices;
automatically transmitting the dagger sports bet to a sports betting server over a network;
processing the dagger sports bet using a dagger bet processor;
storing the dagger sports bet in a dagger bet database;
retrieving real-time information associated with the dagger sports bet from a real-time information aggregator module;
determining the outcome of the dagger sports bet based on the retrieved real-time information; and
updating user account bankrolls based on the outcome of the dagger sports bet.

2. The method of claim 1, further comprising:
causing to display a plurality of dagger sports betting options on one or more user devices; and
causing to allow users to select from the displayed dagger sports betting options to place a dagger sports bet.

3. The method of claim 1, wherein the real-time information aggregator module retrieves real-time information including scores, statistics, winners/losers, dagger shots, and dagger points.

4. The method of claim 1, further comprising:
offering parlay bets of at least two dagger sports bets; and
offering a parlay bet that combines the at least two dagger sports bets with at least one traditional wagering options.

5. The method of claim 1, wherein the sports betting system adjusts the odds of available dagger sports bets based on data from the real-time game information.

6. The method of claim 1, wherein the sports betting system provides users with at least one of tools and resources to assist in making informed decisions when placing dagger sports bets, including at least one of expert predictions, analysis, and breakdowns of upcoming dagger sports betting options.

7. The method of claim 1, further comprising an automatic leaderboard for ranking users based on the results of either dagger sports bets alone or a dagger sports bets in combination with other traditional wagers.

8. The method of claim 1, wherein the sports betting system automatically determines betting odds for available dagger sports bets in real-time based on at least one of past statistics of dagger points and dagger wagering.

9. The method of claim 1, wherein the sports betting system allows in-game dagger sports betting, enabling users to place real-time bets as the real-time event is occurring, and adjusting the odds of available dagger sports bets based on data from real-time information.

10. The method of claim 1, wherein the sports betting system operates to allow a plurality of users to place bets on dagger sports bets and provides real-time odds for a wager to be placed within a particular time frame.

11. The method of claim 1, further comprising a notification system for alerting users of real-time updates, including at least one of changes in odds, the status of their dagger sports bets, and game outcome, and event updates.

12. The method of claim 1, wherein the sports betting system provides at least one of a sportsbook capable of receiving dagger sports bets against a bookmaker and a betting exchange for betting against other users on one or more other user devices.

13. The method of claim 1, further comprising a user interface for managing and tracking the user's dagger sports bets, including bet history, bet outcomes, and user account bankroll updates.

14. The method of claim 1, wherein the dagger sports betting system supports a variety of sports, leagues, and events for users to place dagger sports bets on.

15. The method of claim 1, wherein the sports betting system provides users the option to cash out their dagger sports bets before the conclusion of the game or event, based on real-time odds and the current status of their bets.

16. The method of claim 1, further comprising a user rewards system, wherein users are awarded points, bonuses, or other incentives based on their dagger sports betting activity and performance.

17. The method of claim 1, wherein the sports betting system implements security measures to protect user information, account details, and financial transactions related to dagger sports betting.

18. The method of claim 1, wherein the dagger sports betting system includes a recommendation engine that suggests dagger sports bets based on at least one of a user's betting history, preferences, and performance.

19. The method of claim 1, further comprising a social networking feature that allows users to connect with other users, share their dagger sports bets, and discuss game and event outcomes, strategies, and analysis.

20. A dagger sports betting method, comprising:
providing a sports betting platform accessible by a plurality of user devices;
facilitating communication between said sports betting platform and said user devices over a network;
receiving and managing dagger sports bets on said sports betting platform;
offering real-time odds and allowing in-game wagering for said dagger sports bets based on data from a real-time event data;
updating user account bankrolls based on the outcomes of said dagger sports bets; and
enabling users to track statistical data and monitor the progress of their dagger sports bets on said sports betting platform.
